(19) United States
(12) Patent Application Publication
(10) Pub. No.: US 2025/0328197 A1
(43) Pub. Date: Oct. 23, 2025

(54) COLLECTION OF RADAR DATA FOR GESTURE RECOGNITION TRAINING

(71) Applicant: TEXAS INSTRUMENTS INCORPORATED, Dallas, TX (US)

(72) Inventors: Sandeep Rao, Bangalore (IN); Akshay Kumar Chandrasekaran, Bangalore (IN)

(21) Appl. No.: 18/813,265

(22) Filed: Aug. 23, 2024

(30) Foreign Application Priority Data
Apr. 10, 2024 (IN) 202441029307

(51) Int. Cl. G06F 3/01; G01S 13/58; G01S 13/62; G06F 3/0488; G06F 3/16

(52) U.S. Cl. CPC G06F 3/017; G01S 13/583; G01S 13/62; G06F 3/0488; G06F 3/167

(57) ABSTRACT

Various embodiments of the present disclosure relate to gathering training data for a neural network, and in particular, to gathering radar data for training a neural network to perform gesture detection via radar. In one example embodiment, a technique for gathering radar data for training a neural network to perform gesture recognition via radar is provided. The technique first includes identifying radar data collected during a time period between a first prompt and a second prompt. Next, the technique includes identifying a subset of the radar data which is associated with a gesture based at least on Doppler processing. Finally, the technique includes labeling the subset of the radar data as the gesture.

### CROSS-REFERENCE TO RELATED APPLICATION

This application is related to, and claims the benefit of priority to, India Provisional Patent Application No. 202441029307, filed on Apr. 19, 2024, and entitled “Automated labeling for mmWave radar gesture training”, which is hereby incorporated by reference in its entirety.

### TECHNICAL FIELD

This disclosure relates generally to computing hardware and software and, in particular, to gathering training data for a neural network.

### BACKGROUND

Gesture recognition describes an area of research in computer vision applications which focuses on the interpretation of human body language using sensors (i.e., cameras, radars, etc.). For example, in the context of machine learning applications, a neural network may be trained to recognize a gesture performed by a user, and in response, perform a task associated with that gesture.

Generally, neural networks are trained to perform a task with copious amounts of training data. For example, to train a network to perform gesture recognition, the network is fed training data associated with one or more gestures, so that the network can learn how to accurately identify specific gestures based on the training data it was fed. As such, it is crucial for networks to be trained on high-quality training data, since the accuracy of a neural network is dependent on the data it is trained on.

Currently, various techniques exist for acquiring training data related to gesture recognition. In one application (a camera-based gesture recognition system), a camera is utilized to capture video data of a user performing gestures. Once captured, the user may then label the video data with the specific gestures performed and supply the labeled data as a training data set. The training data set is representative of data that may be used to train a neural network. In another application (a radar-based gesture recognition system), a radar device is utilized to capture radar data in accompaniment with the camera capturing video data. After capturing the necessary data, the user may then synchronize the radar and video data, label the synchronized data, and supply the labeled data as a training data set. It should be noted that in radar-based gesture recognition systems, the video data which is collected in parallel with the radar data is meant to assist the user in accurately labeling the radar data

Problematically, current methods for gathering training data related to gesture recognition rely on the user manually labeling, and possibly synchronizing, the collected data. As a result, current methods for gathering training data related to gesture recognition are time consuming and prone to user error. Furthermore, neural networks trained to perform gesture recognition with user labeled training data can be inaccurate.

### SUMMARY

Disclosed herein is technology, including systems, methods, and devices for gathering radar data for training a neural network to perform gesture recognition.

In various implementations, a technique for gathering radar data for training a neural network to perform gesture recognition via radar is provided. In one example embodiment, the technique first includes identifying radar data collected during a time period between a first prompt and a second prompt. Next, the technique includes identifying a subset of the radar data which is associated with a gesture based at least on Doppler processing. Finally, the technique includes labeling the subset of the radar data as the gesture.

This Summary is provided to introduce a selection of concepts in a simplified form that are further described below in the Detailed Description. It may be understood that this Summary is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates a labeling process in an implementation.

FIG. 3 illustrates a system in an implementation.

FIG. 4 illustrates an operational sequence in an implementation.

FIG. 5A illustrates an operational environment in an implementation.

FIG. 5B illustrates an operational sequence in an implementation.

FIG. 6 illustrates a user environment in an implementation.

FIG. 7 illustrates a collection process in an implementation.

FIG. 8 illustrates another labeling process in an implementation.

FIG. 9 illustrates an operational scenario in an implementation.

FIG. 10 illustrates an operational scenario in an implementation.

FIG. 11 illustrates an operational scenario in an implementation.

FIG. 12 illustrates a computing system suitable for implementing the various operational environments, architectures, processes, scenarios, and sequences discussed below with respect to the other Figures.

### DETAILED DESCRIPTION

Systems, methods, and devices are disclosed herein for gathering training data for a neural network which will be trained to perform gesture recognition via radar. Training data is representative of the data used to train a neural network to perform a designated task. Typically, networks require a large amount of training data to learn how to accurately perform a task. As a result, the accuracy of a neural network is dependent on the quality of its training data.

Existing techniques for gathering training data related to gesture recognition rely on a user manually labeling data and supplying the labeled data to the training data set of the network. For example, a camera-based gesture recognition system may require a user to label video data of one or more gestures and supply the labeled data to the training data set of the network. Alternatively, other systems, such as a radar-based gesture recognition system, require a user to synchronize radar and video data of one or more gestures, label the synchronized data, and supply the labeled data to the training data set of the network. Problematically, these systems require a huge manual effort by the user. Furthermore, these systems are prone to user error, which can lead to inaccuracies in gesture recognition for when the network is deployed. In contrast, disclosed herein is a new technique for gathering training data related to gesture recognition which solely relies on radar data and no longer requires the user to manually label the gathered data.

In one example embodiment a computer-readable medium having executable instructions related to gathering training data for a neural network stored thereon is provided. The instructions are configured to be executed by processing circuitry, such that when executed, the instructions cause the processing circuitry to gather and label radar data for training a neural network to perform gesture recognition via radar.

In an implementation, the program instructions first cause the processing circuitry to identify radar data associated with a gesture based on an issuance of a first prompt and a second prompt. The first and second prompts may be representative of audio prompts, visual prompts, or another sensory prompt of the like. In an implementation, the first prompt is representative of an instruction which initiates a gesture collection period, while the second prompt is representative of an instruction which terminates the gesture collection period. The gesture collection period is representative of a period of time where a user is allowed to perform a gesture, and where the processing circuitry is allowed to collect radar data of the user performing the gesture.

In an implementation, the user is expected to perform and complete the gesture anytime between the first prompt and the second prompt. For example, the user may be expected to wave their hand from left to right during the time period between the first and second prompts. Any non-gesture related movement including hand retractions to ready the hand for a subsequent gesture should be performed outside of the interval between the first and second prompts. As such, the radar data collected between the first and second prompts is representative of radar data associated with a gesture.

In an implementation, prior to identifying the radar data collected between the two prompts, the instructions first cause the processing circuitry to issue the first and second prompts during a data collection period. The data collection period is representative of a period of time for when the processing circuitry is allowed to collect radar data. In an implementation, the user provides a time delay for issuing the two prompts, and during the data collection period, the instructions cause the processing circuitry to output the first prompt, and after the user designated period of time, output the second prompt. After a termination of the data collection period, the instructions may then cause the processing circuitry to identify the radar data associated with the gesture based on the issuance of the first and second prompts.

In another implementation, the instructions cause the processing circuitry to identify the radar data associated with the gesture based on signals generated by a user input device. For example, the user input device may be representative of a phone, tablet, computer, or another device of the like which includes one or more sensors (i.e., microphone, camera, touch screen, etc.) configured to collect user input such as audio signals, video signals, tactile signals, or another signal of the like. During the data collection period, the user may provide the first and second prompts via the user input device, and after a termination of the data collection period, the processing circuitry may identify the radar data collected between the first and second prompts based on signals received from the user input device.

Next, the instructions cause the processing circuitry to perform Doppler processing on the collected radar data to identify a subset of the radar data consisting of data directly associated with the user performing the gesture. Doppler processing describes a method for capturing the relative velocity between a radar device and a moving target. Within the context of the disclosure, the radar device is stationary. As a result, the processing circuitry may perform Doppler processing to identify radar data associated with a moving target. For example, the processing circuitry may perform Doppler processing on the radar data collected between the first and second prompts to identify a subset of the radar data directly associated with the user performing the gesture (i.e., gesture data).

In an implementation, the instructions also cause the processing circuitry to identify radar data which is not associated with the gesture (i.e., non-gesture data). Non-gesture data is representative of any radar data where the user is not performing the gesture. For example, the instructions may cause the processing circuitry to identify the radar data which was collected within the data collection period, but outside of the first and second prompts. Meaning, the processing circuitry may identify a second set of radar data collected between an initiation of the data collection period and the first prompt, and a third set of radar data collected between the second prompt and a termination of the data collection period.

Finally, the instructions cause the processing circuitry to label the subset of the radar data as the gesture. The instructions further cause the processing circuitry to label the second and third sets of radar data as non-gestures. In an implementation, the processing circuitry is coupled to a memory configured to store labeled data for training a neural network. For example, the processing circuitry may store the labeled gesture data in a first section of the memory and store the labeled non-gesture data in a second section of the memory. In an implementation, the instructions cause the processing circuitry to collect multiple iterations of the labeled gesture data and the labeled non-gesture data.

Advantageously, the proposed technology generates large amounts of training data related to gesture movements, and no longer requires a user to manually label the collected radar data. As such, the proposed solution is less expensive than applications which require a camera for labeling training data of a user performing a gesture. Furthermore, the proposed solution generates a more accurate neural network than other applications which require the user to manually label the training data set.

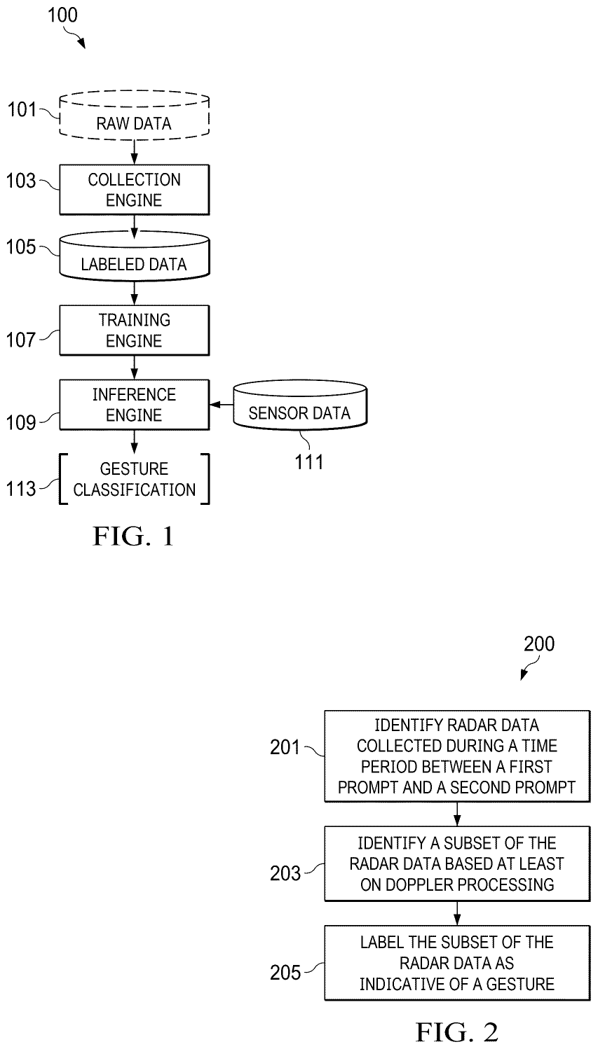

Now turning to the figures, FIG. 1 illustrates operating environment 100 in an implementation. Operating environment 100 is representative of an example environment configurable to gather data for training a neural network to perform gesture recognition via radar. Operating environment 100 includes, but is not limited to, collection engine 103, training engine 107, and inference engine 109.

Collection engine 103 is representative of software, hardware, firmware, or a combination thereof, configured to collect and label data for training a neural network to recognize gestures. For example, collection engine 103 may be representative of a device such as a laptop or a computer, configured to collect and label radar data for training a neural network to perform gesture recognition via radar. Input to collection engine 103 includes raw data 101, and output of collection engine 103 includes labeled data 105.

Raw data 101 is representative of unlabeled radar data, collected by a radar device, for training a neural network. For example, raw data 101 may be representative of ADC samples collected by a radar device of collection engine 103. Raw data 101 includes unlabeled radar data associated with gesture movements, and unlabeled radar data associated with non-gesture movements. In an implementation, raw data 101 is representative of user generated data. For example, during a data collection period, a radar device may collect raw data 101 of a user performing various gesture and non-gesture movements and provide raw data 101 as input to collection engine 103.

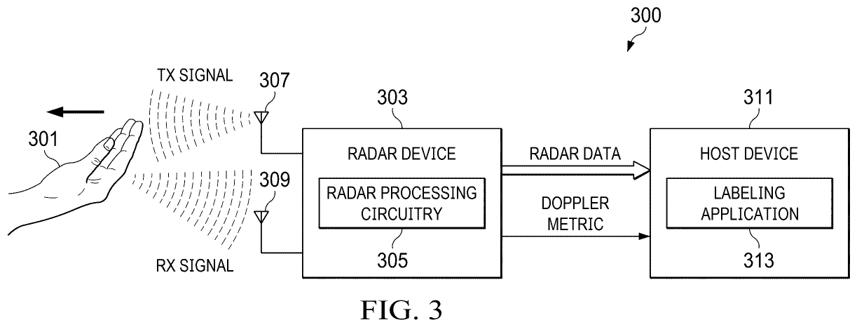

In an implementation, collection engine 103 is configured to determine which subset of raw data 101 is associated with gesture movements and which subset of raw data 101 is associated with non-gesture movements. For example, collection engine 103 may utilize Doppler processing techniques to identify the subset of raw data 101 which is associated with gesture movements, and in turn, the subset of raw data 101 which is associated with non-gesture movements, later discussed in detail with reference to FIG. 2. Once identified, collection engine 103 labels the subset of raw data 101 associated with the gesture movements as gesture data and labels the subset of raw data 101 associated with the non-gesture movements as non-gesture data. As a result, collection engine 103 outputs labeled data 105.

Labeled data 105 is representative of labeled radar data for training a neural network. Labeled data 105 includes labeled radar data associated with gesture movements (i.e., gesture data), and labeled radar data associated with non-gesture movements (i.e., non-gesture data). In an implementation, the gesture data of labeled data 105 includes multiple iterations of labeled radar data which are representative of multiple different gestures. For example, the gesture data may include multiple iterations of radar data associated with a person waving their hand from left to right, a person pinching their thumb and index finger together, and other user generated gestures of the like. In an implementation, after acquiring, analyzing, and labeling the necessary data, collection engine 103 outputs labeled data 105 to training engine 107.

Training engine 107 is representative of software, hardware, firmware, or a combination thereof, configured to train a neural network to perform a designated task. For example, training engine 107 may train a network or machine learning algorithm, such as a convolutional neural network (CNN), artificial neural network (ANN), recurrent neural network (RNN), or another deep neural network of the like (DNN), to perform gesture recognition based on radar data. Input to training engine 107 includes labeled data 105, and output of training engine 107 includes a trained neural network configured to perform gesture recognition via radar.

In an implementation, training engine 107 utilizes labeled data 105 to train a network to perform a task in response to recognizing a gesture. For example, in the context of electric vehicles (EVs), training engine 107 may utilize the gesture data of labeled data 105 to train a network to open the trunk of a car when the network recognizes a user kicking out their foot. In an implementation, training engine 107 also utilizes labeled data 105 to train the network to remain in an off-state for when no gesture is recognized. For example, training engine 107 may utilize the non-gesture data of labeled data 105 to train the network to continue monitoring for gestures when no gesture is recognized. After training the network, training engine 107 outputs the trained neural network to inference engine 109 for deployment.

Inference engine 109 is representative of software, hardware, firmware, or a combination thereof, configured to employ a trained neural network. For example, inference engine 109 may be representative of a processor in an EV configured to perform gesture recognition via radar. Additional example details related to inference engines can be found in commonly assigned U.S. Pat. No. 9,817,109, entitled “Gesture Recognition Using Frequency Modulated Continuous Wave (FMCW) Radar With Low Angle Resolution,” filed on Feb. 27, 2015, U.S. Pat. No. 11,204,647, entitled “System and Method for Radar Gesture Recognition,” filed on February Apr. 13, 2018, U.S. Pat. No. 11,456,713, entitled “Low Power Node of Operation for mmWave Radar,” filed on Apr. 17, 2020, and, U.S. Patent Application Publication No. 2023/0408120, entitled “Room Boundary Detection,” filed on Jul. 29, 2022, all of which are incorporated by reference in their entirety. Input to inference engine 109 includes the output of training engine 107 and sensor data 111, and the output of inference engine 109 includes gesture classification 113.

Sensor data 111 is representative of input data for the trained neural network. As such, sensor data 111 is representative of radar data associated with an environment. In an implementation, inference engine 109 receives sensor data 111 and in response executes the trained neural network to determine if a gesture was performed. If a gesture was recognized, inference engine 109 performs an action associated with the recognized gesture. Alternatively, if a gesture was not recognized, inference engine 109 continues to monitor for gesture movement. In both instances, inference engine 109 outputs gesture classification 113. Gesture classification 113 is representative of an identification of the performed gesture. For example, gesture classification 113 may indicate a user waved their hand from left to right. Alternatively, gesture classification 113 may indicate that no gesture was performed.

In a brief operational example, during a data collection period, collection engine 103 collects radar data of a user (or multiple users) performing both gesture movements and non-gesture movements (i.e., raw data 101). After termination of the data collection period, collection engine 103 analyzes raw data 101 to determine which subset of the radar data is associated with gesture movements, and which subset of the radar data is associated with non-gesture movements. For example, collection engine 103 may utilize Doppler processing techniques on raw data 101 to identify the radar data which is associated with the user performing a gesture movement, and in turn which radar data is associated with the user performing a non-gesture movement.

Next, collection engine 103 labels the subsets of raw data 101 as either gesture data or non-gesture data, and outputs labeled data 105 to training engine 107. Training engine 107 utilizes labeled data 105 to train a neural network to perform gesture recognition based on radar data. For example, training engine 107 may train the network to perform a task based on a recognized gesture. Training engine 107 may further train the network to continue monitoring for gesture movement for when no gesture is recognized. Once the network is trained, training engine 107 outputs the trained network to inference engine 109. Inference engine 109 deploys the trained network and begins collecting sensor data 111. The trained network analyzes the received sensor data and in response outputs gesture classification 113. Gesture classification 113 may either indicate that a gesture was performed or that no gesture was performed.

FIG. 2 illustrates labeling process 200 in an implementation. Labeling process 200 is representative of a process for generating labeled data for training a neural network to perform gesture recognition via radar. Labeling process 200 may be implemented in the context of program instructions that, when executed by a suitable computing system, direct the processing circuitry of the computing system to operate as follows, referring parenthetically to the steps in FIG. 2. For the purposes of explanation, labeling process 200 will be explained with the elements of FIG. 1. This is not meant to limit the applications of labeling process 200, but rather to provide an example.

To begin, collection engine 103 identifies (e.g., selects) the radar data from raw data 101 which was collected during a time period between a first prompt and a second prompt (step 201). In an implementation, raw data 101 is collected during a data collection period. The data collection period describes a period of time for when collection engine 103 is allowed to collect radar data for training a neural network to perform gesture recognition via radar. In an implementation, while collecting radar data during the data collection period, collection engine 103 issues a first prompt which instructs the user to perform a gesture, and after a period of time, issues a second prompt which terminates the period for when the user is allowed to perform the gesture. The first and second prompts may be representative of audio prompts, visual prompts, or another sensory prompt of the like which provides instructions to the user. The radar data collected between the first and second prompts is representative of unlabeled gesture data.

In another implementation, a user issues the first and second prompts via a user input device. The user input device may be representative of a phone, tablet, or computer, including one or more sensors configured to collect input from the user. The one or more sensors of the user input device may include a microphone, camera, or a touch device such as a touchscreen, touchpad, keyboard, keypad, button, remote controller, or another touch device of the like. During the data collection period, the user can supply the first and second prompts via sensors of the user input device. After termination of or during the data collection period, collection engine 103 may identify the radar data collected between the first and second prompts based on signals provided by the user input device.

Next, collection engine 103 identifies (e.g., selects) a subset of the radar data, from the radar data collected between the first and second prompts, based at least on Doppler processing techniques (step 203). The subset of the radar data is representative of radar data directly associated with the gesture movement. For example, if the duration of time between the first and second prompts is equal to five seconds, and the amount of time to execute the gesture is equal to two seconds, then the radar data collected between the first and second prompts represents the radar data collected during the five second duration between the two prompts, and the subset of the radar data represents the radar data that was collected during the two seconds for when the gesture was performed.

In an implementation, to identify the subset of radar data which is directly associated with the gesture movement, collection engine 103 performs Doppler processing on the radar data collected between the first prompt and the second prompt and selects the subset of radar data based on the Doppler processing. Doppler processing describes a technique for determining the relative velocity between a radar device and a moving target. In the context of the disclosure, Doppler processing may be performed on the radar data collected between the first and second prompts to identify the subset of radar data associated with the user performing the gesture. In an implementation, collection engine 103 performs Doppler processing on the radar data collected between the first and second prompts to determine a Doppler metric. The Doppler metric is representative of a metric which captures the motion content of the moving target across time.

After identifying the subset of radar data which is directly associated with the user performing the gesture, collection engine 103 labels the subset of the radar data as indicative of the performed gesture (step 205). For example, if the performed gesture included the user performing a “zoom-in” gesture (by bringing their thumb and index finger together), then collection engine 103 may label the subset of the radar data as “zoom-in”. In an implementation, collection engine 103 is also configured to identify and label radar data which is associated with non-gesture movements. For example, collection engine 103 may identify the radar data collected between an initiation of the data collection period and the issuance of the first prompt and label the radar data as non-gesture data. Collection engine 103 may further identify the radar data collected between the issuance of the second prompt and a termination of the data collection period and label the radar data as non-gesture data.

In an implementation, collection engine 103 executes labeling process 200 multiple times to collect multiple iterations of gesture and non-gesture data. Advantageously, collecting multiple iterations of the data improves the ability of the network to distinguish between the user performing gesture and non-gesture movements.

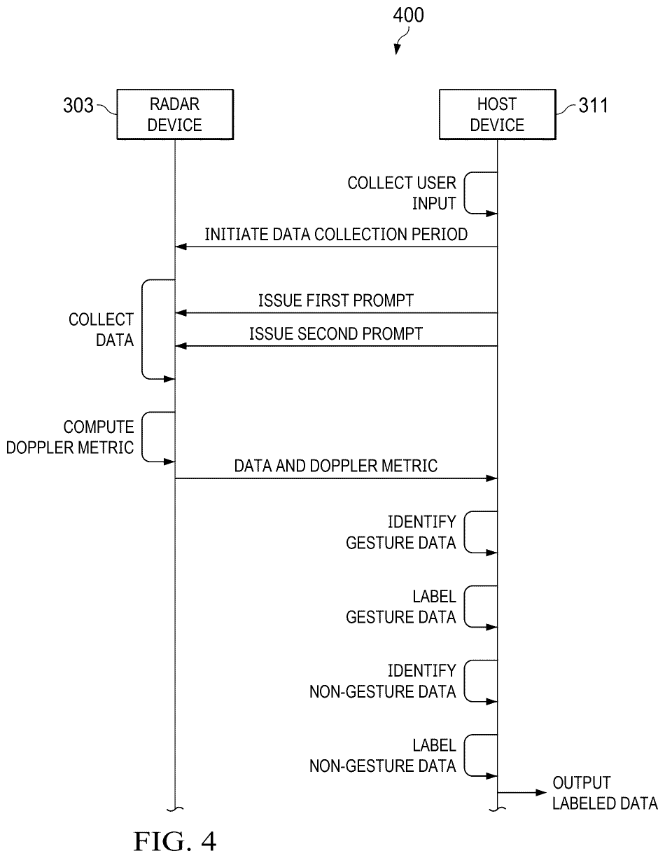

FIG. 3 illustrates system 300 in an implementation. System 300 is representative of a data collection system configured to collect radar data for training a neural network to perform gesture recognition via radar. For example, system 300 may be representative of collection engine 103 of FIG. 1. System 300 includes, but is not limited to, user 301, radar device 303, and host device 311.

User 301 is representative of a person who performs both gesture and non-gesture movements. For example, a gesture movement may be representative of user 301 moving their hand from a first position to a second position. Alternatively, a non-gesture movement may be representative of user 301 standing still, user 301 retracting their hand after performing a gesture, or user 301 setting up their hand in preparation for performing a subsequent gesture. In an implementation, user 301 performs gesture and non-gesture movements during a data collection period. The data collection period describes a period of time for when radar device 303 is allowed to collect radar data.

Radar device 303 is representative of a device configured to collect radar data related to gesture movements and non-gesture movements. In an implementation, radar device 303 is also configured to process the collected data to identify the radar data which captures the timeframe for when a gesture was performed. Radar device 303 includes radar processing circuitry 305, transceiver antenna 307, and receiver antenna 309.

Radar processing circuitry 305 is representative of circuitry configured to collect and process radar data. For example, radar processing circuitry 305 may be representative of a microcontroller unit (MCU), a central processing unit (CPU), an application-specific integrated circuit (ASIC), or another processing device of the like configured to collect and process radar data related to gesture movements and non-gesture movements. In an implementation, radar processing circuitry 305 includes an analog front-end. For example, radar processing circuitry 305 may include power amplifiers, low noise amplifiers, analog to digital converters (ADCs), filters, and other processing elements of the like.

In an implementation, radar processing circuitry 305 directs transceiver antenna 307 and receiver antenna 309 to collect radar data during the data collection period. Transceiver antenna 307 and receiver antenna 309 are representative of antennas configured to gather radar data of an environment. For example, during the data collection period, radar processing circuitry 305 may direct transceiver antenna 307 to transmit a radar signal (i.e., TX signal) towards user 301, and direct, receiver antenna 309 to collect the radar signal (i.e., RX signal) which is reflected back towards radar device 303. The radar data collected by transceiver antenna 307 and receiver antenna 309 is representative of unprocessed radar data associated with user 301 performing gesture and non-gesture movements.

In an implementation, receiver antenna 309 is configured to output the collected radar data to the analog front end of radar processing circuitry 305. In response, the analog front end of radar processing circuitry 305 is configured to generate ADC samples based on the collected radar data. The ADC samples generated by the analog front end of radar processing circuitry 305 represent processed radar data associated with user 301 performing gesture and non-gesture movements. In an implementation, radar processing circuitry 305 is configured to process the ADC samples to generate unlabeled radar data for host device 311. For example, radar processing circuitry 305 may perform various fast Fourier transforms (FFTs) on the collected ADC samples to generate heatmaps (e.g., Range-Angle heatmaps) which may be supplied as unlabeled radar data to host device 311. Radar processing circuitry 305 may also extract various time metrics from the generated heatmaps and supply the extracted data as unlabeled radar data to host device 311.

In an implementation, radar processing circuitry 305 is also configured to perform Doppler processing on the collected ADC samples to determine a Doppler metric associated with user 301 performing the gesture. The Doppler metric is representative of a metric which captures the motion content (i.e., gesture movements) of a moving target (i.e., user 301) across time. For example, the Doppler metric may be representative of a heat-map, time series data, or another metric of the like. In an implementation, radar processing circuitry 305 is configured to output the unlabeled radar data and associated Doppler metric to host device 311. In response, host device 311 is configured to label the radar data as indicative of a gesture or non-gesture movement, based on the associated Doppler metric.

Host device 311 is representative of a device configured to manage the collection of radar data by radar device 303. For example, host device 311 may be representative of a CPU, MCU, ASIC, or another device of the like. In an implementation, host device 311 is representative of a device configured to initiate the data collection period. For example, host device 311 may output an instruction, such that the instruction directs radar device 303 to begin collecting radar data. In an implementation, during the data collection period, host device 311 is configured to output instructions to user 301. For example, host device 311 may output a first prompt which directs user 301 to perform a gesture, and after a period of time, output a second prompt which directs user 301 that the time period for performing the gesture has ceased. The first and second prompts may be representative of audio prompts, visual prompts, or another sensory prompt of the like which provides instructions to user 301.

In an implementation, host device 311 includes a user interface configured to collect configuration information related to the data collection process. For example, host device 311 may be representative of a laptop which includes a user interface configured to collect various timing parameters from user 301, including a duration of time for the data collection period, a time delay for issuing the first prompt (after initiation of the data collection period), a time delay for issuing the second prompt (after issuance of the first prompt), and a time delay for issuing subsequent iterations of the first prompt (after issuance of a second prompt).

In an implementation, host device 311 is further representative of a device configured to label radar data for training a neural network to perform gesture recognition. For example, host device 311 may receive unlabeled radar data and an associated Doppler metric from radar device 303, and in response, label the radar data based on the associated Doppler metric. In an implementation, host device 311 executes labeling application 313 to label the collected radar data.

Labeling application 313 is representative of software (i.e., labeling process 200), that when executed, causes host device 311 to label radar data associated with gesture movements as gesture data and label radar data associated with non-gesture movements as non-gesture data. In an implementation, user 301 may provide configuration information for configuring labeling application 313 to the user interface of host device 311. For example, user 301 may designate a type of gesture to be performed, a number of times the gesture will be performed, and a location in an associated memory for storing the labeled gesture and non-gesture data via the user interface of host device 311.

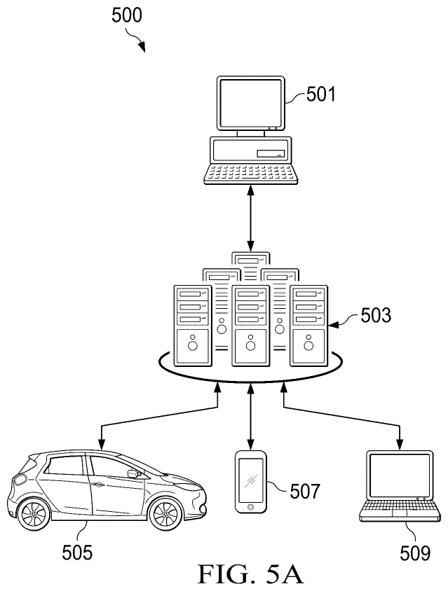

FIG. 4 illustrates operational sequence 400 in an implementation. Operational sequence 400 is representative of a sequence for gathering data for training a neural network to perform gesture recognition with respect to the elements of FIG. 3. As such, operational sequence 400 includes radar device 303 and host device 311.

To begin, user 301 provides configuration information to a user interface of host device 311. For example, user 301 may provide the type of gesture to be performed, a number of times the gesture will be performed, time delays for issuing the prompts, a duration for the data collection period, and a location for storing the labeled radar data. In some examples, some or all of the configuration information is pre-programmed on host device 311.

Next, host device 311 instructs radar device 303 to initiate the data collection period. In an implementation, host device 311 instructs radar device 303 to initiate the data collection period after receiving the configuration information from user 301. In another implementation, user 301 instructs host device 311 to initiate the data collection period via the user interface of host device 311. In either case, after initiation of the data collection period, radar device 303 may begin collecting radar data of user 301. It should be noted that the data collected before the issuance of the first prompt represents radar data associated with non-gesture movements.

Next, host device 311 issues the first prompt. In an implementation, host device 311 issues the first prompt based on the configuration information received from user 301. For example, user 301 may provide a time delay for issuing the first prompt, such that the time delay is representative of a duration host device 311 must wait, after initiation of the data collection period, to issue the first prompt. In another implementation, host device 311 issues the first prompt based on signals received from user 301. For example, host device 311 may include a microphone, camera, or a touch device such as a touchscreen, keyboard, or remote controller configured to receive signals from user 301, such as the first prompt. As just one example, host device 311 may be configured to present a graphical user interface on a touch screen that tells the user to touch the screen (or a button on the screen) before starting the gesture and then to touch the screen (or button) again after ending the gesture.

The first prompt may include an audio prompt, a video prompt, a visual prompt, or any combination of these prompts. The audio prompt may include a bell sound or a voice telling user 301 to perform the gesture. Additionally or alternatively, the video prompt can be displayed on a screen and include text telling user 301 to perform the gesture and/or a video of a person performing the gesture. The visual prompt may include a light, for example, accompanied by an audio prompt telling user 301 to perform the gesture.

The first prompt may communicate information to the user 301. The information communicated by the first prompt may include when, where, and/or how to perform the gesture. For example, the first prompt may tell user 301 to start the gesture, and the second prompt may tell user 301 to stop the gesture. The first prompt may tell user 301 to perform the gesture in the field of view of radar device 303. Additionally or alternatively, the first prompt may tell user 301 the type of gesture to perform.

After host device 311 issues the first prompt, user 301 may perform the indicated gesture. For example, if user 301 configured labeling application 313 to label gesture data of a hand waving from right to left, then after the issuance of the first prompt, user 301 may wave their hand from right to left.

Next, host device 311 issues the second prompt. In an implementation, host device 311 issues the second prompt based on the configuration information received from user 301. For example, user 301 may provide a time delay for issuing the second prompt, such that the time delay is representative of a duration host device 311 must wait, after issuance of the first prompt, to issue the second prompt. In another implementation, host device 311 issues the second prompt based on signals received from user 301. It should be noted that the data collected between the first and second prompts represents radar data associated with a gesture movement.

After host device 311 issues the second prompt, radar device 303 may terminate the data collection period. In an implementation, radar device 303 terminates the data collection period based on the configuration information provided by user 301. For example, user 301 may provide a duration of time for the data collection period, such that the duration describes a time period when transceiver antenna 307 and receiver antenna 309 are allowed to collect radar data. In another implementation radar device 303 terminates the data collection period based on instructions from user 301. For example, user 301 may instruct host device 311 to terminate the collection of radar data by radar device 303. It should be noted that, the data collected after the issuance of the second prompt but before the termination of the data collection period is representative of radar data associated with non-gesture movements.

Next, radar processing circuitry 305 processes the collected radar data to compute the Doppler metric which is associated with user 301 performing the gesture. The Doppler metric is representative of a metric (i.e., heatmaps, time series data, etc.) which captures the motion content of a moving target across time. For example, the Doppler metric may be representative of a metric which can be used to identify the timeframe for when user 301 waved their hand from right to left.

In an implementation, to determine the Doppler metric which is associated with user 301 waving their hand from right to left, radar processing circuitry 305 performs various fast Fourier transforms (FFTs) on the ADC samples which were collected between the first and second prompts. For example, radar processing circuitry 305 may compute Range FFTs and Doppler FFTs, and as a result generate Range-Doppler heatmaps. In another implementation, to determine the Doppler metric which is associated with user 301 waving their hand from right to left, radar processing circuitry 305 further processes the computed heatmaps to extract time series metrics. For example, radar processing circuitry 305 may extract a Doppler average from the computed heatmaps.

In an implementation, radar processing circuitry 305 is also configured to process the collected radar data to generate unlabeled radar data associated with user 301 performing gesture and non-gesture movements. For example, radar processing circuitry 305 may perform Range-FFTs, Doppler-FFTs and Angle-FFTs on the collected ADC samples to generate unlabeled radar data (e.g., Range-Doppler heatmaps and Range-Angle heatmaps) of user 301 performing gesture and non-gesture movements. In another example, radar processing circuitry 305 may extract metrics (e.g., Doppler average, azimuth weighted mean, elevation weighted mean, and Doppler azimuth correlation) from the heatmaps to generate unlabeled radar data of user 301 performing gesture and non-gesture movements.

It should be noted that in some implementations, radar processing circuitry 305 may be instead configured to output the ADC samples to host device 311, and in response, host device 311 may perform the necessary processing on the ADC samples (e.g., Range-FFT, Doppler-FFT, Angle-FFT, or metric extraction) to generate the unlabeled radar data. Furthermore, it should be noted that host device 311 may be instead configured to compute the Doppler metric. For example, radar processing circuitry 305 may output the collected ADC samples to host device 311, and in response, host device 311 may process the collected ADC samples (e.g., Range-FFT, Doppler-FFT, or metric extraction) to compute the Doppler metric.

Next, after computing the Doppler metric, radar device 303 outputs the computed Doppler metric and unlabeled radar data to host device 311. In response, host device 311 executes labeling application 313 to label the radar data. In an implementation, labeling application 313 first causes host device 311 to identify the radar data which is associated with the Doppler metric and label the radar data as gesture data. Next, labeling application 313 causes host device 311 to identify the radar data which was collected between an initiation of the data collection period and the first prompt, and the radar data which was collected between the second prompt and a termination of the data collection period, and label said radar data as non-gesture data. Finally, after labeling the radar data as gesture and non-gesture data, host device 311 outputs the labeled data to a memory associated with system 300. For example, host device 311 may store the labeled gesture data in a location in memory dedicated to the specific gesture type and store the labeled non-gesture data in a location in memory dedicated to non-gesture movements.

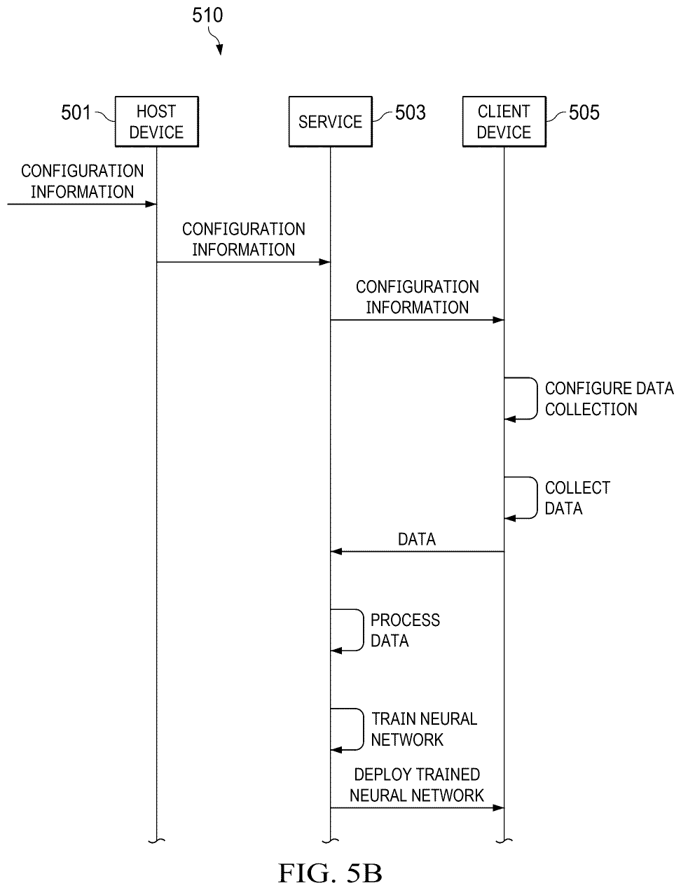

While the foregoing embodiments relate generally to scenarios where the collection of radar data is performed in a local environment, it may be appreciated that the concepts apply as well to global environments where the radar data for training a neural network to perform gesture recognition is collected across multiple client devices. FIG. 5A illustrates one such example operating environment 500 in an implementation. Operating environment 500 is representative of an environment for gathering and labeling radar data for training a neural network to perform gesture recognition via radar. In an implementation, operating environment 500 is further representative of an environment for training and deploying a neural network. As such, operating environment 500 may be representative of operating environment 100 of FIG. 1. Operating environment 500 includes, but is not limited to, host device 501, service 503, and client devices 505, 507, and 509.

Host device 501 is representative of a device configured to manage the collection of radar data across multiple different devices. For example, host device 501 may be representative of a phone, computer, or another device of the like configured to manage the collection of radar data across client devices 505, 507, and 509. In an implementation, host device 501 includes a user interface configured to collect configuration information for configuring the data collection across client devices 505, 507, and 509. For example, a user may provide a type of gesture to be performed, a number of times the gesture will be performed, and other inputs of the like to the user interface of host device 501. Host device 501 may then supply the configuration information to service 503, and in turn client devices 505, 507, and 509.

Service 503 is representative of one or more application services configured to provide various functionalities. For example, service 503 may include application services related to data collection, data labeling, neural network training, and other functionalities of the like. Application services related to data collection are representative of applications configured to provide configuration information to client devices 505, 507, and 509. For example, after receiving the configuration information from host device 501, the application services of service 503 may then configure client devices 505, 507, and 509 to collect radar data of a specific gesture and output the data to the application services of service 503 which are related to data labeling.

The application services related to data labeling are representative of applications configured to label the collected radar data as indicative of a gesture movement or a non-gesture movement. For example, the application services of service 503 may be representative of labeling process 200. In an implementation, the application services related to data labeling are further representative of storage servers configured to store the labeled radar data. For example, the storage servers may include a first location configured to store gesture data collected by the various client devices, and a second location to store non-gesture data.

In an implementation, after labeling radar data as indicative of a gesture or non-gesture, service 503 supplies the labeled radar data to the application services related to neural network training. The application services related to neural network training are representative of applications configured to train a neural network to perform gesture recognition via radar. For example, the application services of service 503 may be representative of training engine 107 of FIG. 1. In an implementation, after training a network to perform gesture recognition, service 503 may deploy the trained network to client devices 505, 507, and 509.

Client devices 505, 507, and 509 are representative of various user input devices configured to collect data for training a neural network to perform gesture recognition via radar. For example, client devices 505, 507, and 509 may respectively represent a vehicle, phone, and laptop configured to collect radar data of a user performing gesture and non-gesture movements. In an implementation, client devices 505, 507, and 509 are configured to collect data during a data collection period. The data collection period is representative of a period of time, designated by the user of host device 501, where client devices 505, 507, and 509 are allowed to collect data associated with a user performing gesture and non-gesture movements. For example, during the data collection period, client device 505, 507, and 509 may collect ADC samples of their respective users performing gesture and non-gesture movements

In an implementation, client devices 505, 507, and 509 are further representative of devices configured to deploy a trained neural network. For example, client devices 505, 507, and 509 may each represent inference engine 109 of FIG. 1. It should be noted that, while illustrated as different devices (i.e., vehicle, phone, and laptop) client devices 505, 507, and 509 may be representative of the same type of device. Furthermore, it should be noted that client devices 505, 507, and 509 are not restricted to the illustrated devices and may instead be representative of a computer, tablet, or another device of the like configured to collect radar data and deploy a trained neural network to perform gesture recognition via radar

FIG. 5B illustrates operational sequence 510 in an implementation. Operational sequence 510 is representative of a sequence for gathering radar data and training a neural network to perform gesture recognition with respect to the elements of FIG. 5A. As such, operational sequence 510 includes host device 501, service 503, and client device 505. It should be noted that client device 505 is representative of an exemplary device, and as such, further represents client device 507, client device 509, or another client device of the like.

To begin, a user provides configuration information to the user interface of host device 501. For example, the user may provide a number of gestures to be performed, the type of gestures to be performed, and the number of times each gesture shall be performed. In an implementation, the user also provides various timing parameters such as a duration for the data collection period.

After receiving the necessary configuration information, host device 501 outputs the configuration information to service 503. Service 503 receives the configuration information and routes the configuration information to client device 505. In response, client device 505 processes the configuration information to prepare for the data collection process.

Once prepared, client device 505 may initiate the data collection period. In an implementation, during the data collection period, client device 505 is configured to issue a first prompt and a second prompt. The first and second prompts may be representative of audio prompts, visual prompts, or another prompt of the like which provides instructions to the user of client device 505. More specifically, the first prompt is representative of an instruction which directs the user to perform a gesture, and the second prompt is representative of an instruction which directs the user that the duration for performing the gesture has ceased. As a result, the data collected between the first and second prompts is representative of radar data associated with the user of client device 505 performing the gesture. Furthermore, the data collected within the data collection period, but outside of the first and second prompts is representative of radar data associated with the user of client device 505 performing non-gesture movements.

In an implementation, client device 505 issues the first and second prompts based on the configuration information provided by the user of host device 501. For example, the user of host device 501 may provide a time delay for issuing the first and second prompts. The time delay for issuing the first prompt represents a duration of time client device 505 must wait, after initiation of the data collection period, to issue the first prompt. Alternatively, the time delay for issuing the second prompt represents a duration of time client device 505 must wait, after issuing the first prompt, to issue the second prompt.

After termination of the data collection period, client device 505 outputs the collected data to service 503. In response, an application service of service 503 begins processing the collected data to determine which subset of the collected data is associated with a gesture, and which subset is associated with a non-gesture. In an implementation, to determine which subset of radar data is associated with a gesture, service 503 performs Doppler processing on the radar data collected between the first and second prompts to identify the Doppler metric which is associated with the user of client device 505 performing the gesture. The Doppler metric is representative of a metric which captures a timeframe of radar data for when motion (i.e., gesture movement) occurred.

Alternatively, to determine which subset of radar data is associated with a non-gesture, service 503 identifies the radar data which was collected outside of the first and second prompts. For example, service 503 may identify the radar data collected in between the initiation of the data collection period and the first prompt, as well as the radar data collected in between the second prompt and the termination of the data collection period. Once identified, service 503 may label the radar data associated with the Doppler metric as gesture data and label the radar data collected outside of the two prompts as non-gesture data.

In an implementation, after labeling the radar data as gesture data or non-gesture data, service 503 stores the labeled data in the storage servers of service 503. For example, service 503 may store data of a first gesture in a data file dedicated to that gesture, and store data of a different gesture in a data file dedicated to that different gesture. Service 503 may also store non-gesture data in a data file dedicated to non-gesture data. In an implementation service 503 stores the labeled radar data based on configuration information provided by the user of host device 501. For example, the user of host device 501 may provide a location in service 503 for storing gesture data, and a location for storing non-gesture data.

Next, service 503 trains a neural network to perform gesture recognition based on the labeled data. For example, service 503 may train the network to perform a task in response to identifying a gesture. Service 503 may further train the network to continue monitoring for gesture movement in response to identifying a non-gesture. Once trained, service 503 outputs the trained neural network to client device 505. In response, client device 505 deploys the trained neural network and begins performing gesture recognition via radar.

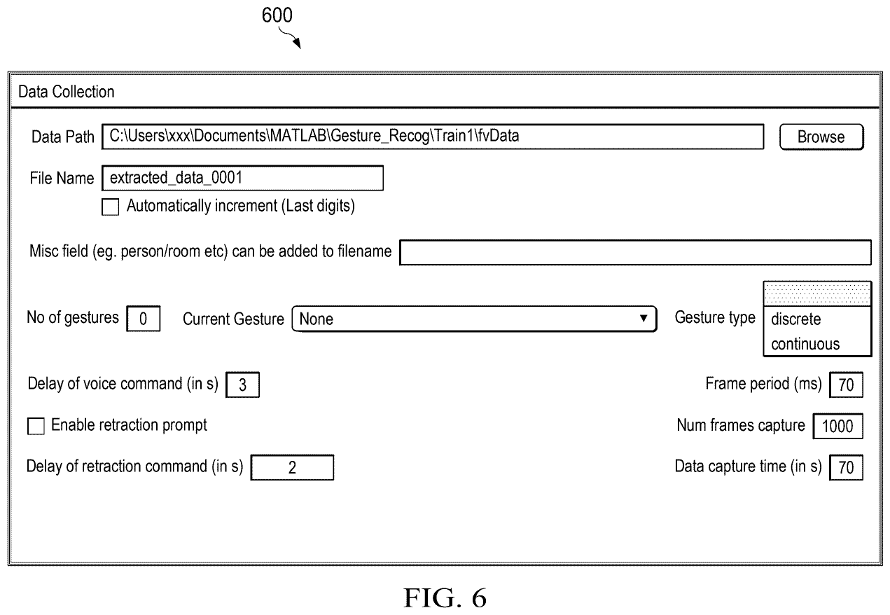

FIG. 6 illustrates user environment 600 in an implementation. User environment 600 is representative of a user interface configured to collect input data related to gesture recognition. For example, user environment 600 may be representative of an interface configured to collect configuration information from a user of host device 501. In another example, user environment 600 is representative of an interface configured to collect user input for configuring system 300. For the purposes of explanation, user environment 600 will be explained with respect to the elements of FIG. 5A. This is not meant to limit the applications of user environment 600, but rather to provide an example.

Prior to operation, a user of host device 501 provides configuration information to an interface of host device 501. In an implementation, the user first provides a location for storing labeled gesture data and labeled non-gesture data. For example, the user may specify a data path within service 503 for storing the labeled gesture and non-gesture data. Additionally, the user may also provide a file name for storing the labeled gesture and non-gesture data.

Next, the user provides a gesture type to the interface of host device 501. For example, the user may specify that the gesture type will be representative of a client lowering their hand from an upper position to a lower position. Once specified, the user provides the number of times the gesture will be performed. In an implementation, during the data collection period, client devices 505, 507, and 509 may issue multiple iterations of the first and second prompts to collect multiple iterations of radar data of the same gesture.

Finally, the user provides various timing parameters to the interface of host device 501. For example, the user may indicate a duration for the data collection period. The user may also indicate time delays for issuing the various prompts. For example, the user may indicate that the first prompt should be issued three seconds after initiation of the data collection period and the second prompt should be issued two seconds after the issuance of the first prompt. In an implementation, the user may also specify a time delay for issuing subsequent iterations of the first prompt. The time delay for the subsequent iterations describes the amount of time client devices 505, 507 and 509 must wait, after issuing a second prompt, to issue a next iteration of the first prompt.

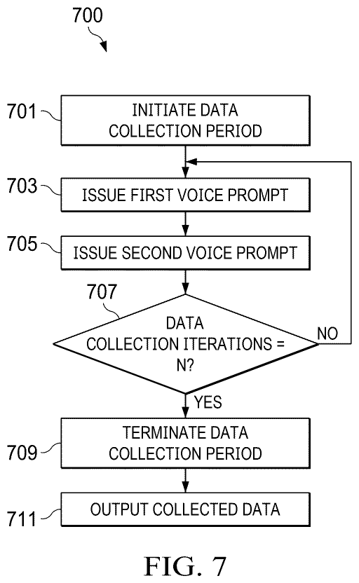

Now turning to the next figure, FIG. 7 illustrates collection process 700 in an implementation. Collection process 700 is representative of a process for collecting data for training a neural network to perform gesture recognition via radar. Collection process 700 may be implemented in the context of program instructions that, when executed by a suitable computing system, direct the processing circuitry of the computing system to operate as follows, referring parenthetically to the steps in FIG. 7. For the purposes of explanation, collection process 700 will be explained with the elements of FIG. 5A. More specifically, collection process 700 will be explained with respect to client device 505. This is not meant to limit the applications of collection process 700, but rather to provide an example.

To begin, client device 505 initiates the data collection period (step 701). In an implementation, client device 505 initiates the data collection period after receiving the configuration information provided by the user of host device 501. In another implementation, client device 505 initiates the data collection period based on instructions provided by the user of client device 505. For example, after receiving the configuration information from service 503, the user of client device 505 may instruct client device 505 to initiate the data collection period.

Next, after initiation of the data collection period, client device 505 issues the first prompt (step 703). The first prompt is representative of an instruction which directs the user of client device 505 to perform a specific gesture. For example, the first prompt may be representative of an audio prompt, visual prompt, or another prompt of the like which directs the user to wave their hand from left to right.

In an implementation, client device 505 issues the first prompt based on configuration information provided by the user of host device 501. For example, prior to the data collection period, the user of host device 501 may provide a time delay for issuing the first prompt. The time delay for issuing the first prompt describes the duration of time client device 505 must wait, after initiation of the data collection period, to issue the first prompt. In another implementation, client device 505 issues the first prompt based on instructions provided by the user of client device 505. For example, client device 505 may include a microphone, camera, or a touch device such as a touchscreen, touchpad, keyboard, keypad, button, or remote controller configured to collect user input, such as the first prompt.

After a period of time following the first prompt, client device 505 issues the second prompt (step 705). The second prompt may be representative of an audio prompt, visual prompt, or another sensory prompt of the like which instructs the user of client device 505 that the period of time for performing the gesture has terminated. In an implementation, client device 505 issues the second prompt based on the configuration information provided by the user of host device 501. For example, prior to the data collection period, the user may provide a time delay for issuing the second prompt. The time delay for issuing the second prompt describes the duration of time client device 505 must wait, after issuance of the first prompt, to issue the second prompt. In another implementation, client device 505 issues the second prompt based on instructions provided by the user of client device 505. For example, the user of client device 505 may provide input to a sensor of client device 505 such that the input is representative of the second prompt.

Next, client device 505 determines if the number of data collection iterations for the specified gesture has been reached (step 707). In an implementation, prior to the data collection period, the user of host device 501 instructs client device 505 to collect multiple iterations of the same gesture. For example, the user of host device 501 may instruct client device 505 to collect five separate iterations of the user of client device 505 waving their hand from left to right. In operation, client device 505 may utilize the configuration information to determine if the number of data collection iterations for the specific gesture has been reached.

If the number of data collection iterations has not been reached, then client device 505 returns to step 703 to perform a next data collection iteration. In an implementation, to perform the next data collection iteration, client device 505 issues subsequent instances of the first and second prompts based on configuration information provided by the user of host device 501. For example, the user of host device 501 may provide a time delay for issuing subsequent iterations of the first prompt, such that the time delay for the subsequent iterations describes the duration of time client device 505 must wait, after issuance of a second prompt, to issue a subsequent iteration of the first prompt. In another implementation, client device 505 issues subsequent instances of the first and second prompts based on input provided by the user of client device 505. For example, prior to a termination of the data collection period, the user of client device 505 may direct client device 505 to issue the subsequent iterations of the first and second prompts via sensors (i.e., microphone, camera, touchscreen, etc.) of client device 505.

In an implementation, client device 505 continues to issue the first and second prompts until the number of data collection iterations has been reached. For example, if client device 505 is configured to collect five separate iterations of gesture data, then after issuing the first iteration of the first and second prompts, client device 505 will issue a second iteration, third iteration, fourth iteration, and fifth iteration of the first and second prompts to gather five separate instances of the user of client device 505 waving their hand from left to right.

Next, client device 505 terminates the data collection period (step 709). In an implementation, client device 505 terminates the data collection period based on configuration information provided by the user of host device 501. For example, the user of host device 501 may provide a duration of time for the data collection period. In another implementation, client device 505 terminates the data collection period based on instructions provided by the user of client device 505. For example, after collecting the necessary amount of radar data iterations, the user of client device 505 may instruct client device 505 to terminate the data collection period.

Finally, after termination of the data collection period, client device 505 outputs the collected radar data to service 503 (step 711). It should be noted that the collected radar data is representative of ADC samples associated with unlabeled gesture and non-gesture data. Unlabeled gesture data is representative of radar data collected between the iterations of the first and second prompts, while the unlabeled non-gesture data is representative of radar data collected within the data collection period, but outside of the first and second prompts.

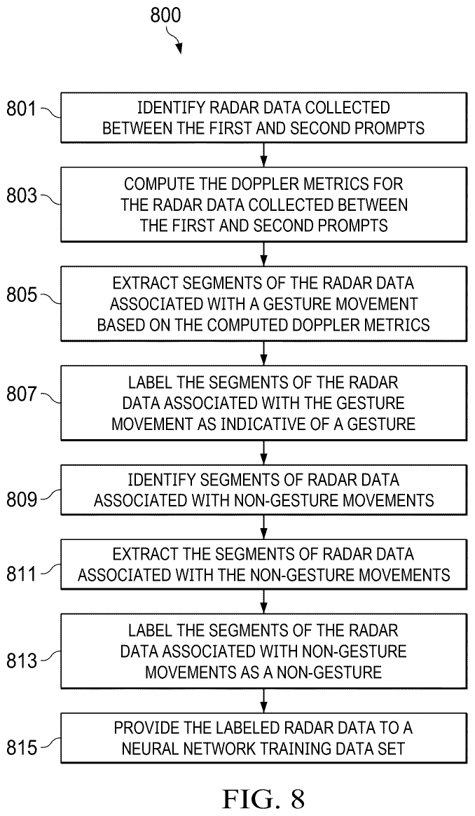

FIG. 8 illustrates labeling process 800 in an implementation. Labeling process 800 is representative of a process for labeling data for training a neural network to perform gesture recognition via radar. For example, labeling process 800 may be representative of labeling application 313 of FIG. 3. Labeling process 800 may be implemented in the context of program instructions that, when executed by a suitable computing system, direct the processing circuitry of the computing system to operate as follows, referring parenthetically to the steps in FIG. 8. For the purposes of explanation, labeling process 800 will be explained as a process for labeling the radar data collected via collection process 700 (with respect to the elements of FIG. 5A). This specification is not meant to limit the applications of labeling process 800, but rather to provide an example.

To begin, service 503 receives unlabeled radar data from client device 505, and in response identifies the radar data which was collected between the first and second prompts (step 801). For example, service 503 may receive ADC samples from client device 505 and in response, identify the ADC samples which were collected between the multiple iterations of the first and second prompts. The ADC samples that were collected between the one or more iterations of the first and second prompts are representative of unlabeled radar data associated with the user of client device 505 performing a gesture movement (i.e., unlabeled gesture data).

Next, service 503 computes the Doppler metrics associated with the user of client device 505 performing the gesture movement (step 803). A Doppler metric is representative of a metric which captures a timeline of radar data for when motion occurred. For example, a Doppler metric may be representative of a metric which captures the timeframe of radar data for when the user of client device 505 performed the gesture movement.

In an implementation, to compute the Doppler metrics associated with the user of client device 505 performing the gesture movement, service 503 performs Doppler processing on the ADC samples collected between the first and second prompts. For example, service 503 may generate Range-Doppler heatmaps for the ADC samples collected between the first and second prompts. The Range-Doppler heatmap is representative of mapping which describes how far away a target (i.e., user of client device 505) is and how quickly the target is moving (i.e., performing a gesture). In an implementation, to compute the Range-Doppler heatmaps service 503 performs a Range Fast Fourier Transform (FFT) and a Doppler FFT on each frame of the radar data collected between the first and second prompts. Next, after generating the Range-Doppler heatmaps, service 503 computes the Doppler metrics for the radar data collected between the first and second prompts based on the generated heatmaps. For example, service 503 may employ the following equation:

$$M = \vert \frac{{\sum }_{i , j} {Z}_{i , j} {D}_{i}}{{\sum }_{i , j} {Z}_{i}} \vert \qquad ( 1 )$$

Such that M is representative of the weighted average of the Range-Doppler heatmap (i.e., Doppler Metric), Z_{i,j} is representative of a heatmap value at cell (i,j) of the Range-Doppler heatmap, Dᵢ is representative of a Doppler value at column (i) of the Range-Doppler heatmap, and Zᵢ is representative of a heatmap value at column (i) of the Range-Doppler heatmap.

After computing the Doppler metrics, service 503 utilizes the computed Doppler metrics to extract segments of radar data directly associated with the user of client device 505 performing the gesture movement (step 805). Next, service 503 labels the extracted radar data associated with the gesture movement as indicative of a gesture (step 807). For example, if the gesture movement was representative of the user of client device 505 waving their hand from left to right, then service 503 may label the segment of extracted radar data as indicative of: “Handwave L:R”.

Next, service 503 identifies segments of radar data associated with non-gesture movements (step 809). In an implementation, to identify segments of radar data associated with non-gesture movements, service 503 identifies the ADC samples which were collected within the data collection period, but outside of the first and second prompts. For example, service 503 may identify the ADC samples which were collected after an initiation of the data collection period but before an issuance of the first prompt, the ADC samples which were collected between the second prompt and subsequent iterations of the first prompt, and ADC samples collected between the final second prompt and a termination of the data collection period.

Next, service 503 extracts the segments of radar data associated with the non-gesture movements (step 811) and labels the segments as indicative of a non-gesture (step 813). Finally, after labeling the gesture and non-gesture data, service 503 may provide the labeled radar data to a machine learning algorithm training data set, e.g., a neural network training data set (step 815). For example, service 503 may provide the labeled data to an application service of service 503 which is configured to a train a neural network to recognize both gesture and non-gesture movements. In an implementation service 503 may train the neural network to perform gesture recognition and output the trained network to client device 505 for deployment.

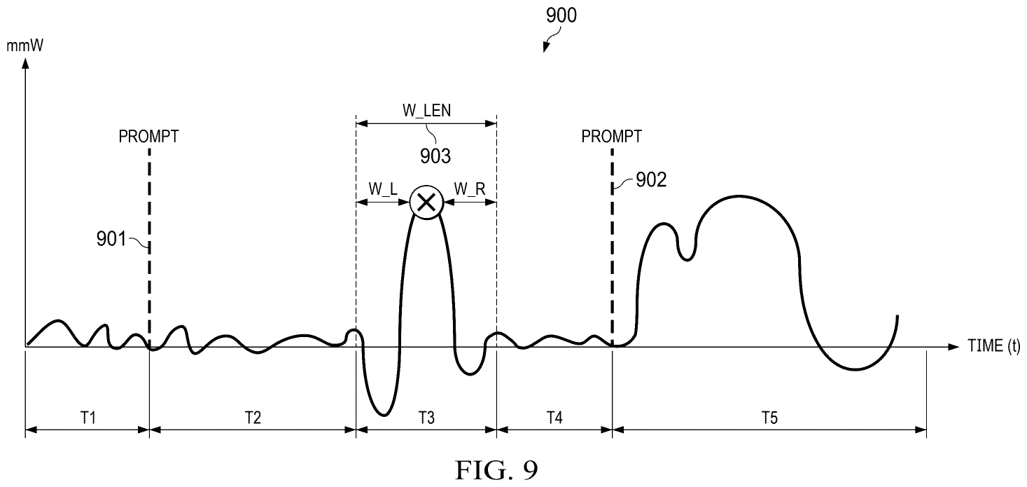

Now turning to the next figure, FIG. 9 illustrates operational scenario 900 in an implementation. Operational scenario 900 is representative of a scenario for gathering data for training a neural network to perform gesture recognition via radar. More specifically, operational scenario 900 is representative of a scenario for collecting radar data associated with a gesture movement and non-gesture movements. In an implementation, operational scenario 900 depicts a graph of a Doppler metric across time (i.e., across radar frames). For the purposes of explanation, operational scenario 900 will be explained with the elements of FIG. 5A. This is not meant to limit the applications of operational scenario 900, but rather to provide an example.

To begin, client device 505 initiates the data collection period, and in response, begins collecting radar data of the user of client device 505 performing non-gesture movements. Next, after a time period following the initiation of the data collection period (i.e., T1), client device 505 issues prompt 901. Prompt 901 is representative of an instruction which directs the user to perform the gesture. For example, prompt 901 may be representative of an audio prompt, visual prompt, or another prompt of the like which instructs the user to wave their hand from left to right.

After client device 505 issues prompt 901, client device 505 may collect radar data associated with the user performing the gesture movement. Next, after a time period following the issuance of prompt 901 (i.e., T2, T3, and T4), client device 505 issues prompt 902. Prompt 902 is representative of an instruction which directs the user that the time period for performing the gesture has been terminated. For example, prompt 902 may be representative of an audio prompt, visual prompt, or another prompt of the like which instructs the user to stop waving their hand from left to right.

Next, after a time period following prompt 902 (i.e., T5), client device 505 terminates the data collection period and outputs the unlabeled gesture and non-gesture data to service 503. Service 503 receives the unlabeled radar data and in response performs Doppler processing on the radar data to identify the Doppler metric. In an implementation, the Doppler metric is representative of the radar data collected between the time frames of T1 and T5. In another implementation, the Doppler metric is representative of the radar data collected between the first and second prompts (i.e., T2 to T4). For the purposes of explanation, the Doppler metric is representative of the data collected during the data collection period (i.e., T1 to T5).

In an implementation, service 503 analyzes the Doppler metric to identify segment 903. Segment 903 is representative of a subset of the Doppler metric which captures the timeframe for when the gesture was performed. For example, segment 903 may be representative of a segment which captures the timeframe for when the user of client device 505 waved their hand from left to right (i.e., T3). It should be noted that segment 903 may further be representative of radar data collected outside of the illustrated timeframe (i.e., T3).

In an implementation, to identify segment 903, service 503 first identifies the peak of the Doppler metric which was collected between prompts 901 and 902. The peak of the Doppler metric is the point at which the Doppler metric has the highest value between the prompts 901 and 902. Next, service 503 identifies a timeframe of radar data before the identified peak (i.e., W_L), and a timeframe of radar data after the identified peak (i.e., W_R), and labels the identified timeframes as segment 903 (i.e., W_LEN). In an implementation, the timeframe of radar data which was identified before the identified peak is equal to the timeframe of radar data which was identified after the identified peak (i.e., W_L=W_R). In another implementation the timeframe of radar data which was identified before the identified peak is not equal to the timeframe of radar data which was identified after the identified peak (i.e., W_L/W_R). In either case, the resulting timeframe, herein referred to as segment 903, is representative of a fixed length input which is suitable for training neural networks (i.e., ANNs) to perform gesture recognition based on radar data.

In another implementation, to identify segment 903, service 503 first identifies a number of consecutive frames between prompts 901 and 902, such that the sum of the Doppler metric across the identified frames is a maximum. Next, service 503 labels the identified frames as segment 903. Finally, service 503 outputs segment 903 to a training data set, such that segment 903 is representative of a fixed length (W_LEN) input which is suitable for training neural networks to perform gesture recognition via radar.

It should be noted that, while fixed length input may be suitable for training some neural networks, other networks (i.e., RNNs) may accept variable length inputs. For example, to identify segment 903, service 503 may first identify the peak of the Doppler metric which was collected between prompts 901 and 902. Next, service 503 may identify a timeframe of radar data before the identified peak (i.e., W_L), and a timeframe of radar data after the identified peak (i.e., W_R), such that the identified timeframes comprise a Doppler metric value that is always a percentage less than the identified peak value. For example, service 503 may identify timeframes of radar data with a Doppler metric value that is within 10% of the identified peak value. As a result, service 503 may identify the radar data associated with the gesture and output segment 903.

In another example, to identify segment 903, service 503 may identify a window, within the Doppler metric, that captures a percentage of the Doppler metric energy. For example, service 503 may be configured to identify a segment of radar data which captures 90% of the total energy of the Doppler metric between prompts 901 and 902. In an implementation, to identify the window which satisfies the energy criterion, service 503 scans the radar data collected between T2 and T4 to identify the smallest length window which captures the designated amount of energy. As a result, service 503 may identify the window of radar data associated with the gesture and output segment 903. In an implementation, the energy of the Doppler metric in a given window is computed as the sum of the squares of the Doppler metric across the frames within that window

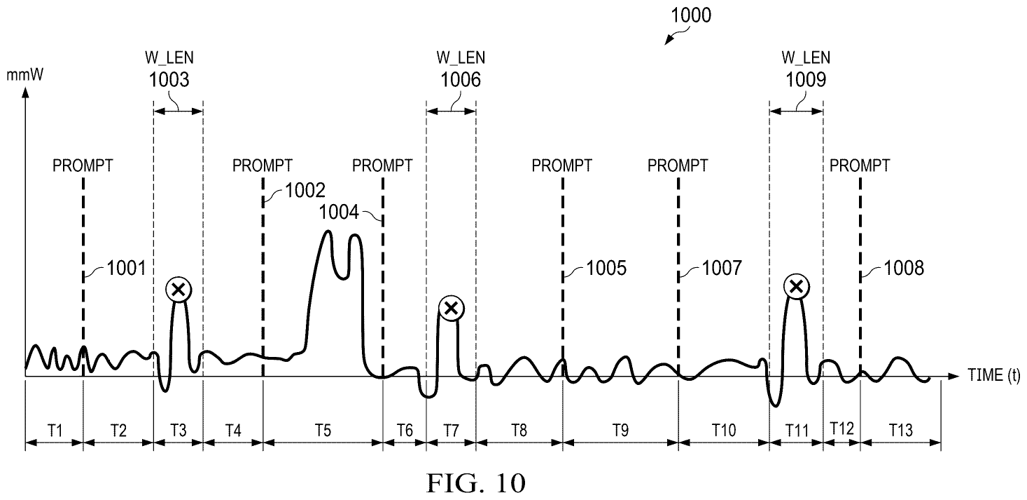

FIG. 10 illustrates operational scenario 1000 in an implementation. Operational scenario 1000 is representative of another scenario for gathering data for training a neural network to perform gesture recognition via radar. More specifically, operational scenario 1000 is representative of a scenario for collecting multiple iterations of radar data associated with a gesture movement and non-gesture movements. In an implementation, operational scenario 1000 depicts a graph of a Doppler metric across time (i.e., across radar frames). For the purposes of explanation, operational scenario 1000 will be explained with the elements of FIG. 5A. This is not meant to limit the applications of operational scenario 1000, but rather to provide an example.

To begin, client device 505 initiates the data collection period, and in response, begins collecting radar data of the user of client device 505 performing non-gesture movements. Next, after a time period following the initiation of the data collection period (i.e., T1), client device 505 issues prompt 1001. Prompt 1001 is representative of an instruction which directs the user to perform the gesture. For example, prompt 1001 may be representative of an audio prompt, visual prompt, or another prompt of the like which instructs the user to wave their hand from left to right.

After client device 505 issues prompt 1001, client device 505 may collect radar data associated with the user performing the gesture movement. Next, after a time period following the issuance of prompt 1001 (i.e., T2, T3, and T4), client device 505 issues prompt 1002. Prompt 1002 is representative of an instruction which directs the user to cease the gesture. For example, prompt 1002 may be representative of an audio prompt, visual prompt, or another prompt of the like which instructs the user that the allowable timeframe for waving their hand from left to right has terminated.

Next, after a time period following prompt 1002 (i.e., T5), client device 505 issues prompt 1004. Prompt 1004 is representative of another instruction which directs the user to perform the gesture. For example, prompt 1004 may direct the user to wave their hand from left to right again.

After client device 505 issues prompt 1004, client device 505 may collect a second iteration of radar data associated with the user performing the gesture movement. Next, after a time period following the issuance of prompt 1004 (i.e., T6, T7, and T8), client device 505 issues prompt 1005. Prompt 1005 is representative of another instruction which directs the user to cease the gesture.

Next, after a time period following prompt 1005 (i.e., T9), client device 505 issues prompt 1007. Prompt 1007 is representative of another instruction which directs the user to perform the same gesture again.

After client device 505 issues prompt 1007, client device 505 may collect a third iteration of radar data associated with the user performing the gesture movement. Next, after a time period following the issuance of prompt 1007 (i.e., T10, T11, and T12), client device 505 issues prompt 1008. Prompt 1008 is representative of another instruction which directs the user to cease the gesture.

Next, after a time period following prompt 1008 (i.e., T13), client device 505 terminates the data collection period and outputs the unlabeled gesture and non-gesture data to service 503. Service 503 receives the unlabeled gesture and non-gesture data and in response performs Doppler processing on the radar data to determine the Doppler metric. The Doppler metric is representative of the radar data collected between the time frames of T1 and T13.

In an implementation, service 503 analyzes the Doppler metric to identify segments 1003, 1006, and 1009. Segments 1003, 1006, and 1009 are representative of subsets of the Doppler metric which capture the timeframes for when the gesture was performed. For example, segment 1003 is representative of a subset that captures the timeframe between prompts 1001 and 1002 for when the user of client device 505 waved their hand from left to right (i.e., T3). Segment 1006 is representative of a subset that captures the timeframe between prompts 1004 and 1005 for when the user of client device 505 waved their hand from left to right (i.e., T7). Segment 1009 is representative of a subset that captures the timeframe between prompts 1007 and 1008 for when the user of client device 505 waved their hand from left to right (i.e., T11). It should be noted that segments 1003, 1006, and 1009 may further be representative of radar data collected outside of the illustrated timeframes (i.e., T3, T7, and T11).

In an implementation, to identify segments 1003, 1006, and 1009, service 503 first identifies the peaks of the Doppler metric which were collected between prompts 1001 and 1002, prompts 1004 and 1005, and prompts 1007 and 1008. Next, service 503 identifies timeframes of radar data before and after the identified peaks and labels the identified timeframes as segments 1003, 1006, and 1009 (i.e., W_LEN). In an implementation, the timeframes of radar data which were identified before the identified peaks are equal to the timeframes of radar data which were identified after the identified peaks. In another implementation the timeframes of radar data which were identified before the identified peaks are not equal to the timeframes of radar data which were identified after the identified peaks. It should be noted that whether the time frames are equal or not is dependent on the type of gesture being performed.

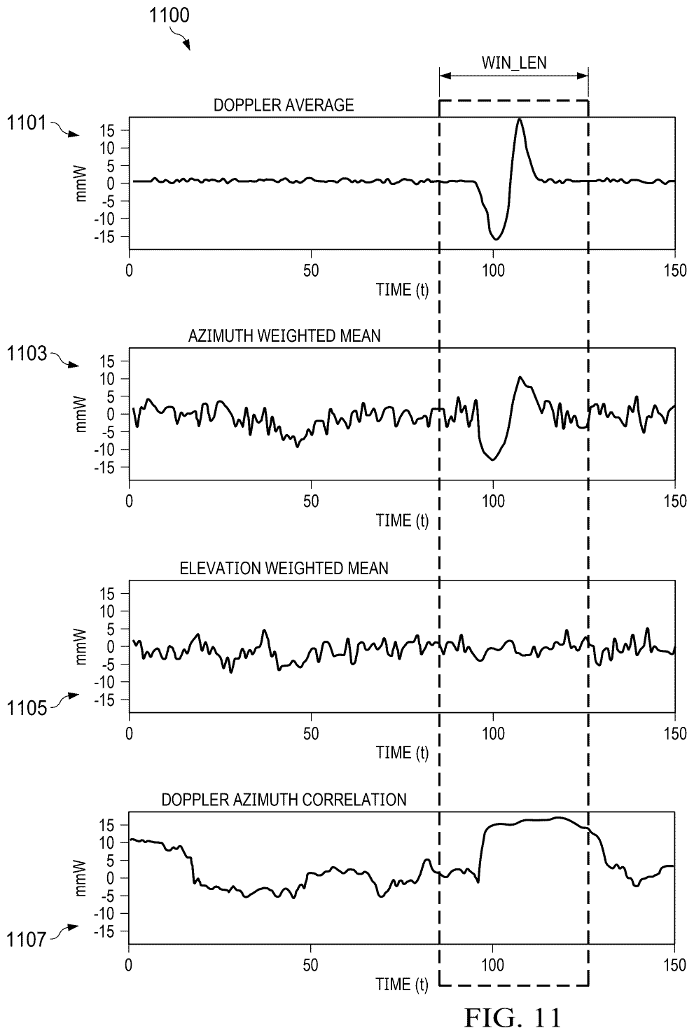

FIG. 11 illustrates operational scenario 1100 in an implementation. Operational scenario 1100 is representative of another scenario for gathering data for training a neural network to perform gesture recognition via radar. More specifically, operational scenario 1100 is representative of a scenario for extracting radar data associated with a gesture movement. For the purposes of explanation, operational scenario 1100 will be explained with the elements of FIG. 5A. This is not meant to limit the applications of operational scenario 1100, but rather to provide an example.

To begin, service 503 analyzes the collected radar data to determine an average Doppler metric for the radar data. The average Doppler metric is representative of a metric which captures the timeframe of radar data for when the gesture occurred. In an implementation, service 503 may perform Doppler processing on the collected radar data to output graph 1101. Graph 1101 is representative of a graph which depicts the average Doppler metric for the collected radar data. In other words, graph 1101 is representative of a graph which depicts the moment in time for when the user of client device 505 performed the gesture.

Next, service 503 analyzes the collected radar data to determine the azimuth weighted mean for the radar data. The azimuth weighted mean is representative of the weighted average distance between the radar device and the user of client device 505. In an implementation, service 503 may analyze the collected radar data to output graph 1103. Graph 1103 is representative of a graph which depicts the azimuth weighted mean for when the user performed the gesture.

Service 503 may further analyze the collected radar data to determine the elevation weighted mean for the radar data. The elevation weighted mean is representative of the weighted average angle between the radar device and the user of client device 505. In an implementation, service 503 may analyze the collected radar data to output graph 1105. Graph 1105 is representative of a graph which depicts the elevation weighted mean for when the user performed the gesture.

Finally, service 503 may analyze the collected radar data to determine the correlation between the Doppler metric and the azimuth weighted mean. In an implementation, service 503 may analyze the collected radar data to output graph 1107. Graph 1107 is representative of a graph which depicts the correlation between the Doppler metric and the azimuth weighted mean.

In an implementation, graphs 1101, 1103, 1105, and 1107 are representative of unlabeled radar data associated with a gesture. For example, graphs 1101, 1103, 1105 and 1107 may be representative of time series data generated from suitably processing ADC samples. In an implementation, service 503 labels the WIN_LEN segment of graphs 1101, 1103, 1105, and 1107 as indicative of the gesture and provides the labeled graphs to a neural network training data set. For example, service 503 may provide the labeled graphs to an application service of service 503 which is configured to a train a neural network to recognize both gesture and non-gesture movements via radar.

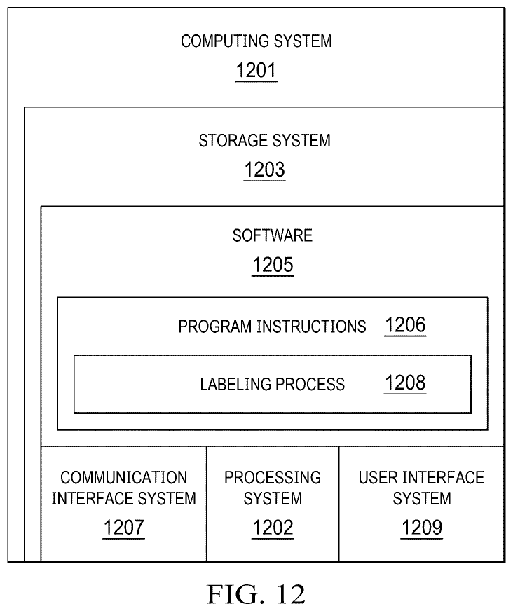

FIG. 12 illustrates an example computer system that may be used in various implementations. For example, computing system 1201 is representative of a computing device capable of collecting and labeling radar data for training a neural network to perform gesture recognition as described herein. Computing system 1201 is representative of any system or collection of systems with which the various operational architectures, processes, scenarios, and sequences disclosed herein for collecting and labeling radar data associated with gesture and non-gesture movements may be employed. Examples of computing system 1201 include—but are not limited to—micro controller units (MCUs), embedded computing devices, server computers, cloud computers, personal computers, mobile phones, and the like.

Computing system 1201 may be implemented as a single apparatus, system, or device or may be implemented in a distributed manner as multiple apparatuses, systems, or devices. Computing system 1201 includes, but is not limited to, processing system 1202, storage system 1203, software 1205, communication interface system 1207, and user interface system 1209 (optional). Processing system 1202 is operatively coupled with storage system 1203, communication interface system 1207, and user interface system 1209. Computing system 1201 may be representative of a cloud computing device, distributed computing device, or the like.

Processing system 1202 loads and executes software 1205 from storage system 1203, or alternatively, runs software 1205 directly from storage system 1203. Software 1205 includes program instructions 1206, which includes labeling process 1208 (i.e., labeling process 200, labeling application 313, collection process 700, or labeling process 800). When executed by processing system 1202, software 1205 directs processing system 1202 to operate as described herein for at least the various processes, operational scenarios, and sequences discussed in the foregoing implementations. Computing device 1201 may optionally include additional devices, features, or functions not discussed for purposes of brevity.

Referring still to FIG. 12, processing system 1202 may comprise a micro-processor and other circuitry that retrieves and executes software 1205 from storage system 1203. Processing system 1202 may be implemented within a single processing device but may also be distributed across multiple processing devices or sub-systems that cooperate in executing program instructions. Examples of processing system 1202 include general purpose central processing units, graphical processing units, digital signal processing units, data processing units, application specific processors, and logic devices, as well as any other type of processing device, combinations, or variations thereof.

Storage system 1203 may comprise any computer readable storage media readable and writeable by processing system 1202 and capable of storing software 1205. Storage system 1203 may include volatile and nonvolatile, removable and non-removable, mutable and non-mutable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1203 may also include computer readable communication media over which at least some of software 1205 may be communicated internally or externally. Storage system 1203 may be implemented as a single storage device but may also be implemented across multiple storage devices or sub-systems co-located or distributed relative to each other. Storage system 1203 may comprise additional elements, such as a controller, capable of communicating with processing system 1202 or possibly other systems.

Software 1205 may be implemented in program instructions 1206 and among other functions may, when executed by processing system 1202, direct processing system 1202 to operate as described with respect to the various operational scenarios, sequences, and processes illustrated herein. In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1205 may include additional processes, programs, or components, such as operating system software, virtualization software, or other application software. Software 1205 may also comprise firmware or some other form of machine-readable processing instructions executable by processing system 1202.

In general, software 1205 may, when loaded into processing system 1202 and executed, transform a suitable apparatus, system, or device (of which computing device 1201 is representative) overall from a general-purpose computing system into a special-purpose computing system customized to support binary convolution operations. Indeed, encoding software 1205 (and labeling process 1208) on storage system 1203 may transform the physical structure of storage system 1203. The specific transformation of the physical structure may depend on various factors in different implementations of this description. Examples of such factors may include, but are not limited to, the technology used to implement the storage media of storage system 1203 and whether the computer-storage media are characterized as primary or secondary, etc.

For example, if the computer readable storage media are implemented as semiconductor-based memory, software 1205 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1207 may include communication connections and devices that allow for communication with other computing systems (not shown) over communication networks (not shown). Examples of connections and devices that together allow for inter-system communication may include network interface cards, antennas, power amplifiers, radiofrequency circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing system 1201 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of networks, or variation thereof. The aforementioned communication networks and protocols are well known and need not be discussed at length here.

As will be appreciated by one skilled in the art, aspects of the present invention may be embodied as a system, method, or computer program product. Accordingly, aspects of the present invention may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific implementations to teach those skilled in the art how to make and use the best mode. For the purpose of teaching inventive principles, some conventional aspects have been simplified or omitted. Those skilled in the art will appreciate variations from these implementations that fall within the scope of the disclosure. Those skilled in the art will also appreciate that the features described above may be combined in various ways to form multiple implementations. As a result, the invention is not limited to the specific implementations described above, but only by the claims and their equivalents.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

1. A non-transitory computer-readable medium having executable instructions stored thereon, configured to be executable by processing circuitry for causing the processing circuitry to:
identify radar data collected during a time period between a first prompt and a second prompt;
identify a subset of the radar data based at least on Doppler processing; and
label the subset of the radar data as a gesture.

2. The non-transitory computer-readable medium of claim 1, wherein the instructions further cause the processing circuitry to:
cause the first prompt to be outputted, wherein the first prompt instructs a user to initiate the gesture; and
after the time period has elapsed after the first prompt has been outputted, cause the second prompt to be outputted, wherein the second prompt instructs the user that a duration for performing the gesture has ceased.

3. The non-transitory computer-readable medium of claim 2, wherein the radar data is collected during a data collection period, and wherein the instructions further direct the processing circuitry to:
cause the first prompt to be outputted after initiation of the data collection period; and
cause the second prompt to be outputted before termination of the data collection period.

4. The non-transitory computer-readable medium of claim 3, wherein the instructions further direct the processing circuitry to:
identify a second set of the radar data collected between the initiation of the data collection period and the first prompt;
identify a third set of the radar data collected between the second prompt and the termination of the data collection period; and
label the second set of the radar data and the third set of the radar data as negative gesture samples.

5. The non-transitory computer-readable medium of claim 1, wherein the first prompt and the second prompt are audio prompts.

6. The non-transitory computer-readable medium of claim 1, wherein the instructions further direct the processing circuitry to identify the first prompt and the second prompt based on signals generated by a user input device.

7. The non-transitory computer-readable medium of claim 6, wherein the user input device includes a microphone configured to generate the signals based on audio received by the microphone.

8. The non-transitory computer-readable medium of claim 6, wherein the user input device includes a touch device.

9. The non-transitory computer-readable medium of claim 1, wherein the instructions further direct the processing circuitry to:
collect the radar data after a user initiates the first prompt;
compute a Doppler metric after the user initiates the first prompt; and
collect a second set of the radar data after the user initiates the second prompt.

10. A method comprising:
collecting radar data during a data collection period;
identifying a set of the radar data collected during a time period between a first prompt and a second prompt;
identifying a subset of the radar data, from the set of the radar data, based at least on Doppler processing; and
labeling the subset of the radar data as a gesture.

11. The method of claim 10, further comprising during the data collection period:
causing the first prompt to be outputted, wherein the first prompt instructs a user to initiate the gesture; and
after the time period has elapsed after the first prompt has been outputted, causing the second prompt to be outputted, wherein the second prompt instructs the user that a duration for performing the gesture has ceased.

12. The method of claim 11 further comprising:
identifying a second set of the radar data collected between an initiation of the data collection period and the first prompt;
identifying a third set of the radar data collected between the second prompt and a termination of the data collection period; and
labeling the second set of the radar data and the third set of the radar data as negative gesture samples.

13. The method of claim 10, wherein the first prompt and the second prompt are audio prompts.

14. The method of claim 10, further comprising identifying the first prompt and the second prompt based on signals generated by a user input device.

15. The method of claim 14, wherein the user input device includes a microphone configured to generate the signals based on audio received by the microphone.

16. The method of claim 14, wherein the user input device includes a touch device.

17. A method comprising:
outputting a first prompt to instruct a user to perform a first instance of a gesture;
collecting sensor data after the first prompt;
outputting a second prompt to instruct the user to stop the first instance of the gesture after outputting the first prompt;
training a machine learning algorithm using the sensor data collected between the first and second prompts; and
detecting a second instance of the gesture using the machine learning algorithm.

18. The method of claim 17, further comprising performing range-Doppler processing on the collected sensor data, wherein training the machine learning algorithm uses the range-Doppler processed sensor data.

19. The method of claim 17,
wherein outputting the first prompt including outputting a first audio prompt via a speaker, and
wherein outputting the second prompt including outputting a second audio prompt via the speaker.

20. The method of claim 17,
wherein outputting the first prompt including outputting a first visual prompt via a display, and
wherein outputting the second prompt including outputting a second visual prompt via the display.
